(19) United States
(12) Patent Application Publication
(10) Pub. No.: US 2026/0093363 A1
(43) Pub. Date: Apr. 2, 2026

(54) INPUT SYSTEM AND INPUT METHOD

(71) Applicant: Wacom Co., Ltd., Saitama (JP)

(72) Inventors: Tsukasa NOMI, Saitama (JP); Hideki FUJIMAKI, Saitama (JP)

(73) Assignee: Wacom Co., Ltd., Saitama (JP)

(21) Appl. No.: 19/410,884

(22) Filed: Dec. 5, 2025

Related U.S. Application Data
(63) Continuation of application No. PCT/JP2024/027368, filed on Jul. 31, 2024.
(60) Provisional application No. 63/516,768, filed on Jul. 31, 2023.

(51) Int. Cl. G06F 3/042; G06F 1/16; G06F 3/0354

(52) U.S. Cl. CPC G06F 3/0425; G06F 1/163; G06F 1/1686; G06F 3/03545

(57) ABSTRACT

An input system includes at least one processor that performs a detecting process that executes an image processing process on an image signal acquired from a camera to detect a sensor device and that acquires a device state quantity representing a position and posture of the sensor device in a display coordinate space. The at least one processor performs a calculating process that calculates coordinate transformation rules for mapping a sensor coordinate space onto the display coordinate space by using the device state quantity acquired. The at least one processor performs a transforming process that transforms a first stylus state quantity representing a position and posture of an electronic stylus in the sensor coordinate space to a second stylus state quantity representing a position and posture of the electronic stylus in the display coordinate space according to the calculated coordinate transformation rules.

### BACKGROUND

### Technical Field

The present disclosure relates to an input system and an input method.

### Description of the Related Art

Heretofore, there has been known a digital ink system that is capable of creating digital ink data descriptive of a set of strokes created through handwriting actions performed by pointing devices such as electronic styluses. One problem is, in response to a handwriting input entered by a user, the digital ink system may display handwritten content at a point different from the point where the handwriting input is entered.

JP2013/125487 discloses a technology for establishing a two-dimensional virtual plane in a three-dimensional space and thereafter displaying strokes handwritten by a user on the two-dimensional virtual plane immediately on a display device that is wearable by the user.

Using a wearable display device such as a pair of augmented reality (AR) glasses, a user can have a simulated experience of seeing handwritten strokes left in the field of view when the wearable display device overlappingly displays various objects in the field of view. According to the technology disclosed in JP2013/125487, however, since the two-dimensional virtual plane remains fixed in place after being established, the handwritten content may in some cases be displayed at a point not intended by the user, resulting in a disruption to the operability for the user to make handwriting inputs.

### BRIEF SUMMARY

The present disclosure is made in view of the above-described problem, and one embodiment of the present disclosure provides an input system and an input method that are capable of improving the operability of the user to make handwriting inputs in an apparatus configuration that includes, as separate components, a sensor device for detecting the position and posture of an electronic stylus and a wearable display device for displaying a space.

In accordance with an aspect of the present disclosure, there is provided an input system including an electronic stylus and a sensor device including a planar stylus sensor capable of detecting a position and posture of the electronic stylus. In addition, there is a wearable display device that is wearable by a user to cover his or her eyes that includes a camera for capturing an image of a space at least in front of the user and at least one processor for performing display control on the wearable display device to display a virtual object in a display area of the wearable display device. The at least one processor performs a detecting process that executes an image processing process on an image signal acquired from the camera to detect the sensor device and that acquires a device state quantity representing a position and posture of the sensor device in a display coordinate space defined for the display control. It also performs a calculating process that calculates coordinate transformation rules for mapping a sensor coordinate space defined by the sensor device onto the display coordinate space by using the device state quantity acquired by the detecting process. It also performs a transforming process that transforms a first stylus state quantity representing a position and posture of the electronic stylus in the sensor coordinate space to a second stylus state quantity representing a position and posture of the electronic stylus in the display coordinate space according to the calculated coordinate transformation rules.

In accordance with another aspect of the present disclosure, there is also provided an input method using an input system including an electronic stylus, a sensor device including a planar stylus sensor capable of detecting a position and posture of the electronic stylus, a wearable display device that is wearable by a user to cover his or her eyes that includes a camera for capturing an image of a space at least in front of the user, and at least one processor for performing display control on the wearable display device to display a virtual object in a display area of the wearable display device. The input method includes, by the at least one processor, a detecting step that performs an image processing process on an image signal acquired from the camera to detect the sensor device and acquires a device state quantity representing a position and posture of the sensor device in a display coordinate space defined for the display control. It also includes a calculating step that calculates coordinate transformation rules for mapping a sensor coordinate space defined by the sensor device onto the display coordinate space by using the device state quantity acquired by the detecting step, and a transforming step that transforms a first stylus state quantity representing a position and posture of the electronic stylus in the sensor coordinate space to a second stylus state quantity representing a position and posture of the electronic stylus in the display coordinate space according to the calculated coordinate transformation rules.

According to the present disclosure, the operability for the user to make handwriting inputs is improved in an apparatus configuration that includes, as separate components, a sensor device for detecting the position and posture of an electronic stylus and a wearable display device for displaying a space.

### BRIEF DESCRIPTION OF THE SEVERAL VIEWS OF THE DRAWINGS

FIG. 1 is a view of an overall configuration of an input system according to an embodiment of the present disclosure;

FIG. 2 is a block diagram illustrating an example of AR glasses included in the input system illustrated in FIG. 1;

FIG. 3 is a state transition diagram illustrating a transition between operation modes that are performed by the input system illustrated in FIG. 1;

FIG. 4 is a view illustrating an example of a pick-up action on a virtual object;

FIG. 5 is a view illustrating an example of a drop-off action on a virtual object;

FIG. 6 is a view illustrating an example of the layout of haptic devices included in an electronic stylus illustrated in FIG. 1;

FIG. 7 is a view illustrating an example of relation between movement of the electronic stylus and operation of a haptic device;

FIG. 8 is a diagram illustrating a first example of how a sensor coordinate space and a display coordinate space are mapped onto each other;

FIG. 9 is a flowchart of a stylus tracking operation performed by the AR glasses illustrated in FIG. 2;

FIG. 10 is a diagram illustrating an example of a process of acquiring state quantities of devices in the sensor coordinate space and the display coordinate space;

FIG. 11 is a diagram illustrating a second example of how a sensor coordinate space and a display coordinate space are mapped onto each other;

FIG. 12 is a view illustrating an example of a mode of displaying a seamless object; and

FIG. 13 is a view illustrating an example of a result of an action performed on a seamless object.

### DETAILED DESCRIPTION

A preferred embodiment of the present disclosure will be described in detail below with reference to the accompanying drawings. For an easier understanding of the embodiment, identical components illustrated in the drawings are denoted by identical reference characters as much as possible throughout views and will be omitted from detailed description. Further, the term “section” used herein may be replaced with any of other terms including a unit, a module, a device, or an element, for example.

### Makeup of Input System 10

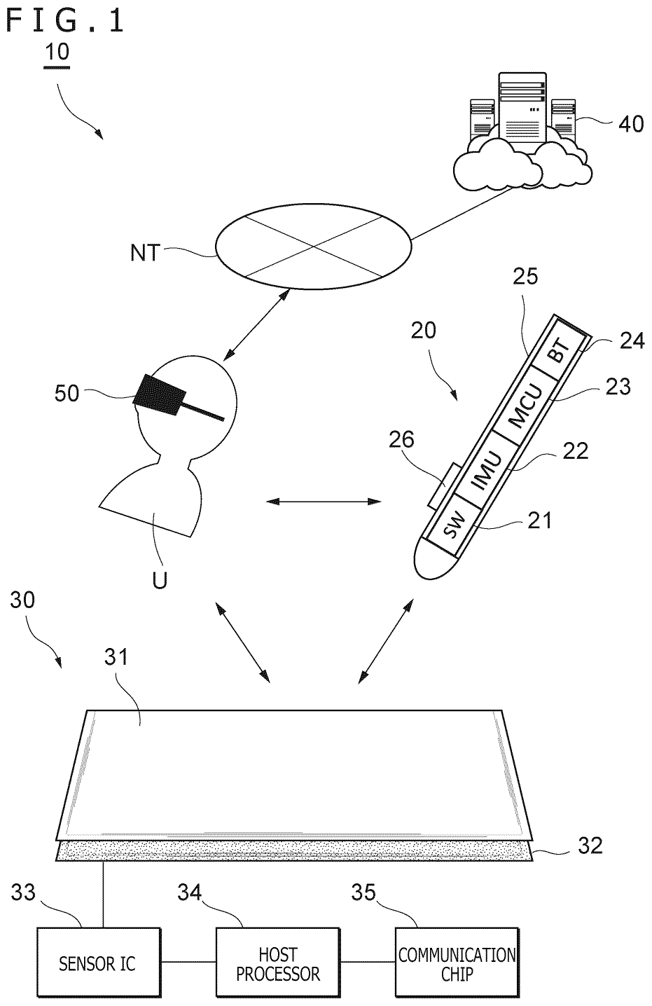

Original digital handwriting systems have suffered a problem in that a user of a display is unable to look around at the entirety of the content on the display when they are displayed at an enlarged scale, due to physical restrictions imposed by the display. According to one solution, display extension based on AR is performed from a sensor surface of the display to provide a new digital handwriting service that is free of the physical restrictions of the display area of the display. Further, it is preferable to track an electronic stylus uninterruptedly on the display for operating the extended display zone and indicating other wide display zones. According to the present embodiment, there is proposed an input system 10 (see FIG. 1) that is capable of tracking the position of an electronic stylus uninterruptedly even at a blind spot of a camera combined with AR glasses.

### Overall Configuration

FIG. 1 illustrates an overall configuration of the input system 10 according to the present embodiment. The input system 10 is a digital ink system that creates digital ink data descriptive of a set of strokes created by handwriting actions performed using an electronic stylus 20 and holds the digital ink data ready for use. As illustrated in FIG. 1, the input system 10 includes at least one electronic stylus 20, at least one sensor device 30, and a server 40.

The electronic stylus 20 represents a pointing device capable of communicating unidirectionally or bidirectionally with the sensor device 30. The electronic stylus 20 may be operable on either the active capacitance (AES) or electromagnetic resonance (EMR) principle. For example, the electronic stylus 20 includes a stylus pressure sensor 21, an inertial measurement unit (IMU) 22, a microcontroller unit (MCU) 23, and a communication chip 24. The electronic stylus 20 has a casing 25 with an operating switch 26 mounted on a side thereof.

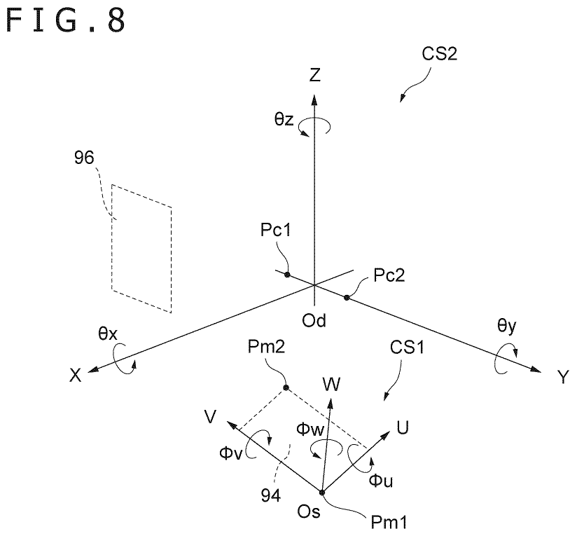

The stylus pressure sensor 21 is a pressure sensor, for example, including a variable capacitor for detecting a change in capacitance that occurs when a pressure is applied to a stylus tip of the electronic stylus 20. The stylus pressure sensor 21 is able to detect not only a stylus pressure but also stylus events including a lifting movement and a lowering movement of the electronic stylus 20. The IMU 22 is a measurement unit including a combination of a three-axis gyro sensor and a three-directional acceleration sensor, for example. The IMU 22 thus configured is capable of measuring state quantities indicative of the state of its own device or time-dependent changes in the state in a sensor coordinate space CS1 (see FIG. 8) to be described later. The state quantities include various physical quantities used to specify a position and posture, e.g., a position, speed, acceleration, jerk, an angle, and angular velocity.

The MCU 23 is a control unit including a processor capable of controlling operation of the electronic stylus 20. For example, the MCU 23 performs various processing operations with regard to the calculation of a position indicated by the electronic stylus 20 and a process of controlling the transmission and reception of data including the results of the processing operations. Moreover, using the technology disclosed in JP2022/037377, the MCU 23 is able to determine a position and posture in the sensor coordinate space CS1 (see FIG. 8) by transforming state quantities of the electronic stylus 20 according to predetermined transformation rules and successively adding the transformed state quantities.

The communication chip 24 is an integrated circuit (IC) for performing wireless communication with an external device according to various wireless communication standards including Bluetooth (registered trademark) or Ultra-Wide Band (UWB). The communication chip 24 enables the electronic stylus 20 to exchange various kinds of data with the sensor device 30.

The sensor device 30 is a device capable of detecting a position indicated by the electronic stylus 20 and may or may not have a display function. The user, denoted by U, can hold the electronic stylus 20 with one hand and move the stylus tip to a touch surface 31 of the sensor device 30 and press the stylus tip against the touch surface 31 to write pictures and letters in a display area thereof.

The sensor device 30 is a computer owned by the user U, for example, and may be in the form of a tablet terminal, a smartphone, or a personal computer that may or may not have a display function. Alternatively, the sensor device 30 may be a paper-like device specializing in a function to detect the electronic stylus 20. Further alternatively, the sensor device 30 may be a device incorporated in an object in a building, e.g., a home electric appliance, a piece of furniture, or a fixture, or a device incorporated in a part of a building, e.g., a wall, a floor, a window, or a pillar.

According to the embodiment illustrated in FIG. 1, the sensor device 30 includes a planar stylus sensor 32, a sensor IC 33, a host processor 34, and a communication chip 35.

The stylus sensor 32 is a planar sensor for detecting a position and posture of the electronic stylus 20. If the electronic stylus 20 is an AES stylus, then the stylus sensor 32 is a capacitive touch sensor. If the electronic stylus 20 is an EMR stylus, then the stylus sensor 32 is an EMR sensor having a plurality of detecting coils arranged in a planar layout for detecting an alternating magnetic field.

The capacitive touch sensor includes, for example, a plurality of X-line electrodes for detecting X-axis positions in a sensor coordinate system and a plurality of Y-line electrodes for detecting Y-axis positions in the sensor coordinate system. The capacitive touch sensor may be a self-capacitance sensor having a two-dimensional grid of block-shaped electrodes in place of the mutual-capacitance sensor described above.

The EMR sensor may partly or wholly be combined with other components of the sensor device 30. For example, the EMR sensor may have transmission coils (power coils) integrally incorporated in a light-source board of a display panel and detecting coils integrally incorporated in a touch sensor.

The stylus sensor 32 may be either a built-in (more specifically, on-cell or in-cell) sensor integrally combined with a display panel such as a liquid-crystal panel or an organic electroluminescence (EL) panel or an external (or outer-cell) sensor attached to an outer side of a display panel.

The sensor IC 33 is an IC for controlling the driving of the stylus sensor 32. The sensor IC 33 drives the stylus sensor 32 on the basis of control signals supplied from the host processor 34. The sensor IC 33 thus performs a stylus detecting function to detect the state of the electronic stylus 20. If the stylus sensor 32 is a capacitive touch sensor, then the sensor IC 33 further performs a touch detecting function to detect whether or not the touch surface 31 is touched by a passive pointer such as a user's finger and also detects the position where the touch surface 31 is touched by the passive pointer.

The host processor 34 includes a processing device including a central processing unit (CPU), a graphic processing unit (GPU), or a microprocessing unit (MPU). The host processor 34 can perform various functions including the generation of digital ink data and the transmission and reception of data, for example, by reading programs stored in an undepicted memory and executing the read programs.

As with the communication chip 24, the communication chip 35 is an IC for performing wireless communication with an external device according to various wireless communication standards including Bluetooth (registered trademark) or UWB. The communication chip 35 enables the sensor device 30 to exchange various kinds of data with the electronic stylus 20 or the server 40. The server 40 is a computer for performing an overall control process with regard to the management of digital ink data. The server 40 may be of the cloud type or the on-premise type.

Though the server 40 is illustrated as a single computer, it may alternatively include a group of computers used to construct a distributed system.

The input system 10 further includes, in addition to the electronic stylus 20, the sensor device 30, and the server 40, a pair of AR glasses 50, which may be referred to as a wearable display device, that the user U can wear in covering relation to his or her eyes. The AR glasses 50 are capable of communicating with the electronic stylus 20 or the sensor device 30 by way of wireless communication. Moreover, the AR glasses 50 are capable of communicating with the server 40 via a network NT. In this manner, an electronic stylus system, which is made up of the electronic stylus 20 and the sensor device 30, and the AR glasses 50 work in collaboration with each other to enable the input system 10 to input information in a sophisticated fashion.

### Block Diagram of Ar Glasses 50

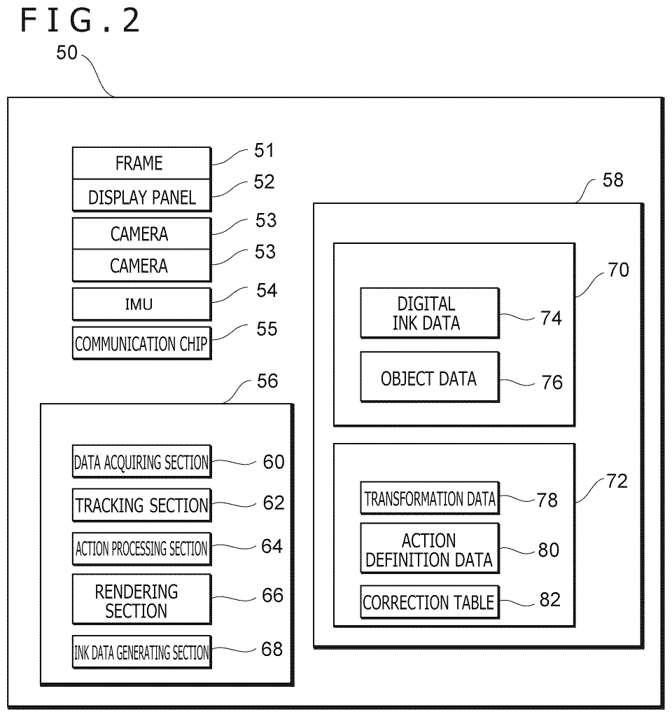

FIG. 2 illustrates in block form an example of the AR glasses 50 included in the input system 10 illustrated in FIG. 1. As illustrated in FIG. 2, the AR glasses 50 include a frame 51, a display panel 52, a pair of cameras 53, an IMU 54, a communication chip 55, a controller 56, and a storage 58.

The frame 51 is a casing, excluding lenses, and includes left and right rims and left and right temples, for example. The frame 51 may be of an eyeglass shape or a goggle shape.

The display panels 52 are fitted in the respective left and right rims in place of lenses. The display panels 52 display images or videos in overlapping relation to an image of a space in front of the user U. The display panels 52 may be liquid-crystal panels, mini light emitting diode (LED) panels, micro LED panels, organic EL panels, or quantum-dot panels, for example.

Each of the cameras 53 is an image capturing device for generating frame-by-frame signals representing an image captured in a space in front of the user U and outputting the frame signals as image signals representing a chronological sequence of images. The cameras 53 are fixed to the respective left and right rims of the frame 51 to capture an image of the space in front of the user U. Each of the cameras 53 may include a visible-light camera, an infrared camera, or a time-of-flight (TOF) camera, for example.

As with the IMU 22 illustrated in FIG. 1, the IMU 54 is a measurement unit including a combination of a three-axis gyro sensor and a three-directional acceleration sensor, for example. The IMU 54 thus configured is capable of measuring state quantities indicative of the state of its own device or time-dependent changes in the state in a display coordinate space CS2 (see FIG. 8) to be described later.

As with the communication chips 24 and 35 illustrated in FIG. 1, the communication chip 55 is an IC for performing wireless communication with an external device according to various wireless communication standards including Bluetooth (registered trademark) or UWB. The communication chip 55 enables the AR glasses 50 to exchange various kinds of data with the electronic stylus 20, the sensor device 30, or the server 40.

The controller 56 is configured as a processor including a CPU, a GPU, or an MPU. The controller 56 functions as a data acquiring section 60, a tracking section 62, an action processing section 64, a rendering section 66, and an ink data generating section 68 by reading programs and data stored in the storage 58 and executing the programs.

The data acquiring section 60 performs an acquiring process for acquiring various kinds of data required to input and output information. For example, the data acquiring section 60 acquires image signals from the cameras 53 and acquires measurement signals from the IMU 54. Moreover, the data acquiring section 60 acquires data indicating states of the electronic stylus 20 (e.g., a position, a posture, and a stylus pressure of the electronic stylus 20, and ON/OFF of the operating switch 26) from the sensor device 30 through the communication chip 55. Furthermore, the data acquiring section 60 acquires digital ink data 74 or object data 76 from the sensor device 30 or the server 40 through the communication chip 55.

The tracking section 62 performs a tracking process for tracking the electronic stylus 20 or the sensor device 30 by using various kinds of data acquired by the data acquiring section 60. The tracking process is performed by successively performing (1) a detecting process for detecting the sensor device 30, (2) a calculating process for calculating coordinate transformation rules, and (3) a transforming process for transforming stylus state quantities.

The detecting process referred to above includes (1) an image processing operation for acquiring the position in an image of a feature zone of the electronic stylus 20 or the sensor device 30 from image signals captured by the cameras 53 and (2) a coordinate transforming operation for transforming the position in the image into a position and posture in the display coordinate space CS2 according to the triangulation method. The feature zone is shaped as a point, a line, or a combination thereof. Examples of the feature zone include (1) part of an outer shape of the sensor device 30 that includes a contour and a mark, (2) an external marker detachably applied to the sensor device 30, and (3) a mark displayed on the sensor device 30. A state quantity with regard to the position and posture of the feature zone of the sensor device 30 will hereafter be referred to as a “device state quantity.”

The calculating process referred to above includes (1) an acquiring operation for acquiring a pair of device state quantities and (2) a rule determining process for determining coordinate transformation rules from the pair of device state quantities.

The pair of device state quantities referred to above with regard to the acquiring operation mean a combination of a device state quantity in the sensor coordinate space CS1 (see FIG. 8) and a device state quantity in the display coordinate space CS2 (see FIG. 8). The sensor coordinate space CS1 represents a two-dimensional or three-dimensional orthogonal coordinate space that is defined in the sensor device 30 and used in detection control on the electronic stylus 20. The display coordinate space CS2 represents a three-dimensional orthogonal coordinate space that is defined in the AR glasses 50 and used in display control on the display panel 52.

The coordinate transformation rules referred to above with regard to the rule determining process mean operation rules for mapping the sensor coordinate space CS1 onto the display coordinate space CS2. The operation rules are described by a three-dimensional affine transformation matrix that is represented by a combination of linear transformation (rotation, expansion and contraction, and shearing) and translation, for example. The transformation matrix can be obtained by solving a simultaneous linear equation, for example.

The transforming process referred to above includes (1) a transforming operation for transforming a stylus state quantity according to the coordinate transformation rules, (2) a selecting operation for selecting one of a plurality of stylus state quantities, and (3) a correcting operation for correcting a stylus state quantity.

The stylus state quantity referred above with regard to the transforming operation means a state quantity representing a position and posture of the electronic stylus 20. The transforming operation makes it possible to transform a stylus state quantity in the sensor coordinate space CS1 (hereinafter referred to as a “first stylus state quantity”) into a stylus state quantity in the display coordinate space CS2 (hereinafter referred to as a “second stylus state quantity”).

The selecting operation referred to above with regard to the transforming process may include selecting the first stylus state quantity. The first stylus state quantity represents, for example, a detected value detected by the stylus sensor 32 or a cumulative value obtained by accumulating distances that the electronic stylus 20 has moved and that have been successively measured by the IMU 22 of the electronic stylus 20. For example, if both the detected value and the cumulative value are acquired, then the detected value that is of relatively higher positional accuracy is selected as the first stylus state quantity. If either one of the detected value and the cumulative value is not acquired, then the other value that is acquired is selected as the first stylus state quantity. If the detected value that is detected in a present cycle is not acquired, then the detected value that has been acquired in a preceding cycle is selected as the first stylus state quantity.

The selecting operation may also include selecting the second stylus state quantity. The second stylus state quantity represents, for example, a transformed value obtained by the transforming process or a detected value obtained by detection of the electronic stylus 20 in the detecting process. For example, if both the transformed value and the detected value are acquired, then the transformed value that is of relatively higher positional accuracy is selected as the second stylus state quantity. If either one of the transformed value and the detected value is not acquired, then the other value that is acquired is selected as the second stylus state quantity. If the transformed value that is transformed in a present cycle is not acquired, then the transformed value that has been acquired in a preceding cycle is selected as the second stylus state quantity.

The action processing section 64 performs an action processing process for analyzing the state of the electronic stylus 20 or time-depending change in the state of the electronic stylus 20 and determining contents of a stylus action. The action processing process includes (1) a selecting process for selecting a stylus action, (2) a determining process for determining action contents, or (3) a commanding process for commanding the electronic stylus 20.

The selecting process referred to above is a data processing process for selecting whether a stylus action made by the user U using the electronic stylus 20 is an action based on a first stylus state quantity (hereinafter referred to as a “first action”) or an action based on a second stylus state quantity (hereinafter referred to as a “second action”). Whether or not the selecting process is available or action targets to be selected differ depending on the configuration of the input system 10.

According to a first example, if the AR glasses 50 have both functions of inputting and outputting the digital ink data 74, then the selecting process is omitted. In other words, of the first and second actions, the second action is selected at all times.

According to a second example, if the sensor device 30 and the AR glasses 50 divide up the functions of inputting and outputting the digital ink data 74, then the selecting process is performed on action targets. Specifically, the selecting process selects whether a stylus action made by the user U is an action on the sensor device 30, i.e., the first action, or an action on the AR glasses, i.e., the second action. The action targets are selected automatically or manually.

According to a third example, if the sensor device 30 and the AR glasses 50 divide up the functions of inputting and outputting the digital ink data 74, then the selecting process is performed on coordinate spaces. Specifically, the selecting process selects whether a stylus action made by the user U is an action on the sensor coordinate space CS1, i.e., the first action, or an action on the display coordinate space CS2, i.e., the second action. The coordinate spaces are selected automatically or manually.

Examples of determining conditions for determining automatic selection include (1) whether there is a stylus pressure acting on the electronic stylus 20 or not and an amount of stylus pressure, (2) the intensity of a signal received by the electronic stylus 20, and (3) a type of an operation mode. For example, if a stylus pressure is detected, then the first action is selected, and if a stylus pressure is not detected, then the second action is selected. If the intensity of the received signal is equal to or lower than a threshold value, then the first action is selected, and if the intensity of the received signal is higher than the threshold value, then the second action is selected. The first action is selected while an operation mode for limiting an action target to the sensor device 30 is being carried out, and the second action is selected while an operation mode for limiting an action target to the AR glasses 50 is being carried out. Moreover, if an action target is both the sensor device 30 and the AR glasses 50, then the first action or the second action may dynamically be selected according to other determining conditions.

Examples of determining conditions for determining manual selection include (1) the action state of the switch 26 of the electronic stylus 20, (2) the action state of the sensor device 30, and (3) a gesture made using the electronic stylus 20. For example, the first action is selected normally, and the second action is selected while the switch 26 is being depressed. The first action and the second action are switched over via user controls displayed on the sensor device 30. Moreover, the first action and the second action are toggled each time a shaking action is applied to shake the electronic stylus 20.

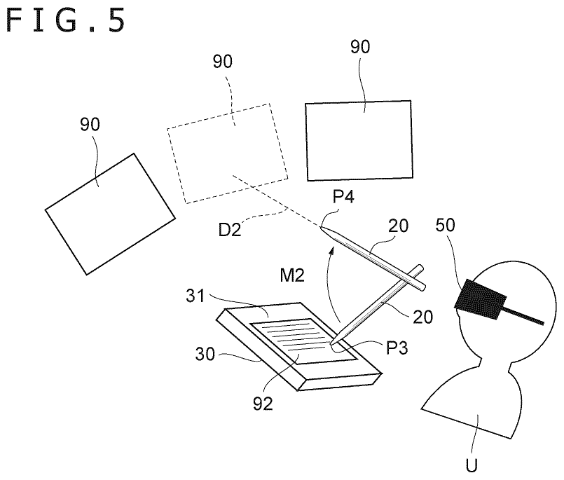

The determining process referred to above specifically is a data processing process for analyzing the state of the electronic stylus 20 or time-depending change in the state of the electronic stylus 20 from the second stylus state quantity supplied from the tracking section 62 and specifying the contents of an action corresponding to the result of the analysis. The second action includes various actions such as (1) a stroke action for plotting handwritten content and (2) an object action for the user U to edit virtual objects 90 (see FIG. 5) in a space displayed on the AR glasses 50. The object action includes a pick-up action and a drop-off action, for example.

The pick-up action is an action for moving a virtual object 90 positioned outside of the sensor device 30 to the position of the sensor device 30. The drop-off action is an action, after the pick-up action, for moving a virtual object 90 (see FIG. 5) at the position of the sensor device 30 to a position outside of the sensor device 30. The pick-up action or the drop-off action includes an action for dragging and dropping a virtual object 90 by making a change in the position or direction pointed by the electronic stylus 20. The dragging and dropping action may be activated while the switch 26 of the electronic stylus 20 is being operated, for example.

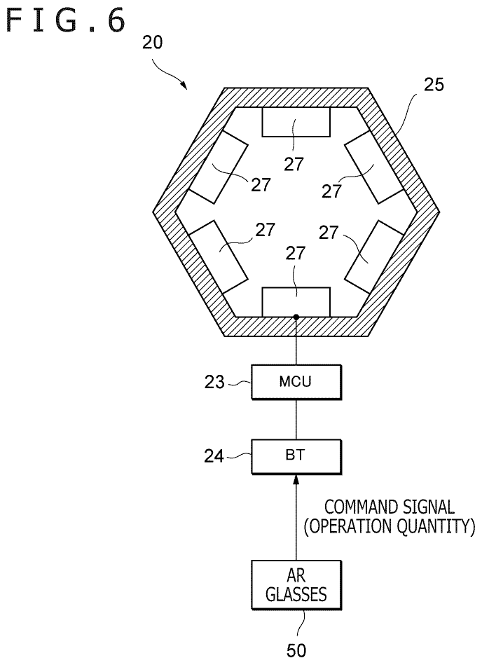

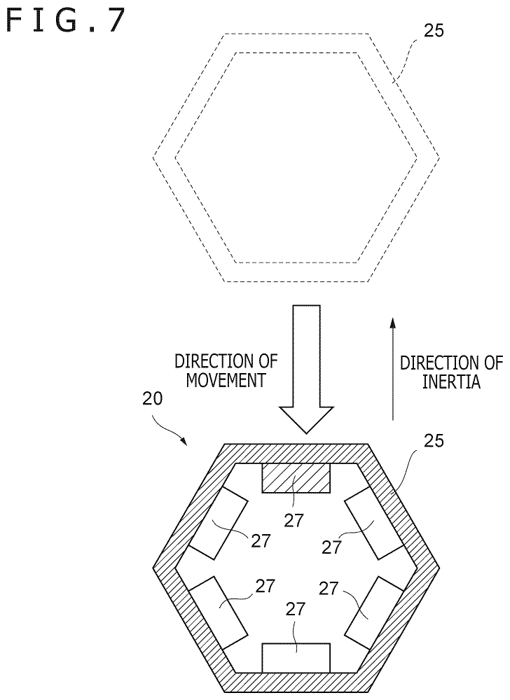

The commanding process referred to above is a data processing process for outputting command signals to enable haptic devices 27 (see FIGS. 6 and 7) to perform a desired operation providing the electronic stylus 20 includes the haptic devices 27, for example. A specific example of the commanding process will be described later with reference to FIGS. 5 and 6.

The rendering section 66 performs a rendering process for displaying virtual objects 90 according to the contents of an action specified by the action processing section 64. The rendering process includes (1) an assistance displaying process with regard to a stylus action, (2) a rasterizing process for rasterizing the digital ink data 74, (3) a layout process for laying out virtual objects 90, (4) a correcting process for correcting the display coordinate space CS2, and (5) a seamlessly displaying process for seamlessly displaying virtual objects 90.

Examples of the assistance displaying process referred to above include (1) a process for displaying action icons, (2) a process for displaying thumbnails of virtual objects 90, (3) a process for displaying an operation mode that is being carried out, and (4) a process for displaying a present action target. The rasterizing process referred to above is a data processing process for converting vector image data described by the digital ink data 74 into raster image data. The layout process referred to above is a data processing process for laying raster image data in an indicated region. The correcting process referred to above is a data processing process for correcting, by using a measured value obtained from the IMU 54, the second state quantity such that the position and posture of the AR glasses 50 agree with a reference state of the display coordinate space CS2.

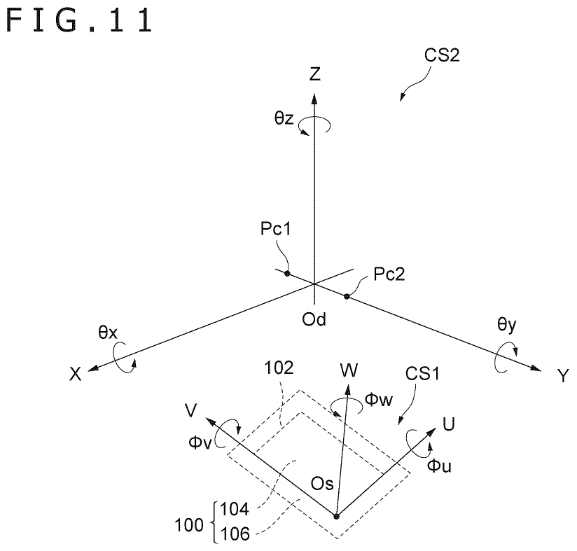

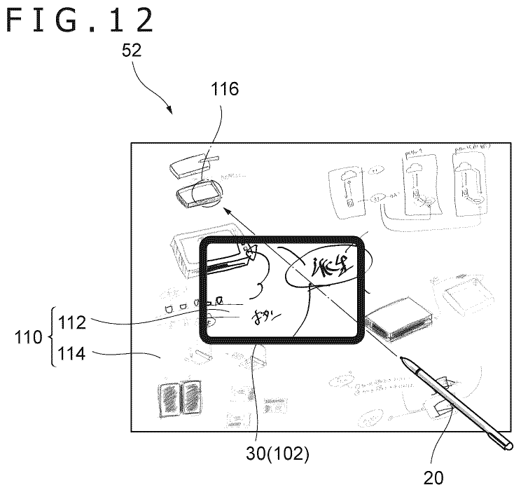

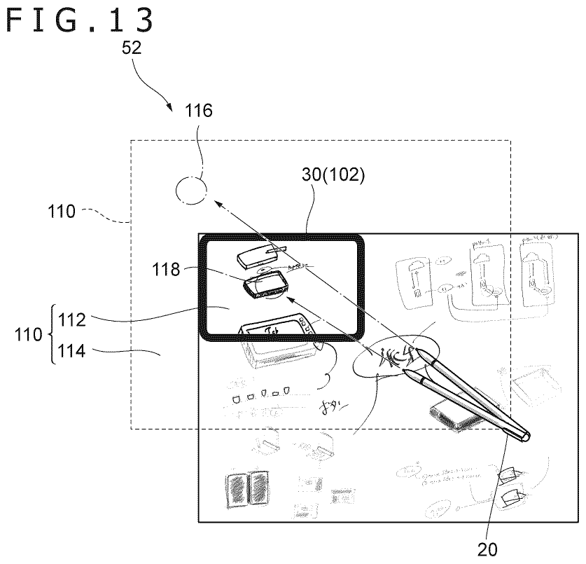

The seamlessly displaying process referred to above is a data processing process for displaying a seamless object 110 (see FIGS. 12 and 13). The seamless object is a virtual object 90 that includes handwritten content formed by a handwriting action on the sensor device 30 and that is seamless at a boundary line 102 (see FIG. 11) of a device region 104 provided by the sensor device 30. The term “seamless” represents not only a completely seamless state but also a state in which a gap or positional shift may be present to the extent that it can be recognized as integral content.

The seamlessly displaying process referred to above is performed in different modes depending on whether or not the sensor device 30 displays an image. Specifically, if the sensor device 30 does not display part of the seamless object 110 in the device region 104, then a region that includes the device region 104 is indicated as the position of the seamless object 110. On the other hand, if the sensor device 30 displays part of the seamless object 110 in the device region 104, then a region excluding the device region 104 is indicated as the position of the seamless object 110.

In the seamless displaying process, an assigning process may be performed to assign a visual effect to an area outside of the device region 104 (hereinafter referred to as an “outer object 114”) for distinguishing the outer object 114 from an area inside of the device region 104 (hereinafter referred to as an “inner object 112”), the outer object 114 and the inner object 112 making up the seamless object 110. The assigning process includes (1) an unsharpening process for converting the outer object 114 to an object that is less sharp than the inner object 112 and (2) an image deforming process for placing the outer object 114 in a deformed state.

Examples of the unsharpening process include (1) a color processing process for lowering lightness, (2) a color processing process for lowering saturation, (3) a color processing process for changing hue, and (4) a masking process (or a filtering process) for lowering a spatial frequency characteristic. Examples of the image deforming process include (1) an image scaling-down process for reducing the size of an image, (2) a panoramic processing process for placing an image in a curved layout in surrounding relation to the user U (what is generally called panoramic display), and (3) a conformance processing process for dynamically changing the shape or layout of an image in conformity with a change in the position and posture of the sensor device 30.

The ink data generating section 68 performs a generating process for creating ink data, i.e., the digital ink data 74, descriptive of handwritten content on the basis of stroke actions specified by the action processing section 64. For creating the digital ink data 74, the ink data generating section 68 may create either “first ink data” for use with the sensor coordinate space CS1 (see FIG. 8) or “second ink data” for use with the display coordinate space CS2 (see FIG. 8) or may simultaneously create both first ink data and second ink data.

The storage 58 stores programs and data required for the controller 56 to control the components of the AR glasses 50. The storage 58 includes a storage medium that is non-transitory and computer-readable. The computer-readable storage medium may be a storage device such as a hard disk drive (HDD) or a solid state drive (SSD) incorporated in a computer system or a portable medium such as a magneto-optical disk, a read only memory (ROM), a compact disc (CD)-ROM, or a flash memory, for example. According to the example illustrated in FIG. 2, the storage 58 stores content data 70 and rendering information 72.

The content data 70 is data descriptive of content displayed in an AR space. The content data 70 includes the digital ink data 74 and the object data 76.

The digital ink data 74 includes ink data for expressing handwritten content. The digital ink data 74 is described by an ink description language such as Wacom Ink Layer Language (WILL), Ink Markup Language (InkML), or an Ink Serialized Format (ISF), for example. The content may represent documents, pictures, calligraphic works and paintings, illustrations, and artwork, for example.

The object data 76 is image data representative of various objects related to the browsing and editing of virtual objects 90. Examples of the object data 76 include handwritten content reproduced from the digital ink data 74, derived content including thumbnails and images for browsing, and user controls such as action icons and status fields.

The rendering information 72 includes various pieces of information regarding the rendering process performed by the AR glasses 50. For example, the rendering information 72 includes transformation data 78, action definition data 80, and a correction table 82.

The transformation data 78 includes mapping information for specifying coordinate transformation rules for coordinate transformation between different coordinate spaces. Examples of the mapping information include matrix elements of coordinate transformation matrixes and state quantities of respective feature points. Examples of the coordinate transformation include (1) transformation from the sensor coordinate space CS1 to the display coordinate space CS2 (see FIG. 8), (2) transformation from a camera coordinate space to the display coordinate space CS2, and (3) transformation from a stylus coordinate space to the sensor coordinate space CS1.

The action definition data 80 includes definition information regarding the definition of action events caused by the electronic stylus 20. Examples of the definition information include types of action events, starting conditions and ending conditions for action events, and the relation between the contents and results of actions.

The correction table 82 is used to correct deviations or shifts of the first stylus state quantity and the second stylus state quantity. With regard to the first stylus state quantity, for example, an input quantity to the correction table 82 represents a cumulative value, and an output quantity from the correction table 82 represents a corrective quantity for canceling out a deviation or shift from a detected value. With regard to the second stylus state quantity, for example, an input quantity to the correction table 82 represents a detected value, and an output quantity from the correction table 82 represents a corrective quantity for canceling out a deviation or shift from a transformed value.

### First Operation of Input System 10

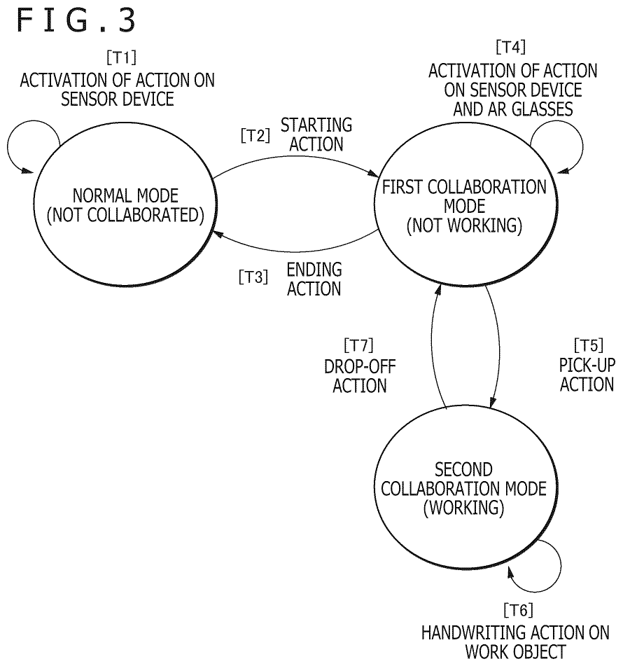

The input system 10 according to the present embodiment is configured as described above. First, an AR-coordinated operation of the input system 10 will be described below with reference to FIGS. 3 through 7. The AR-coordinated operation means an operation for coordinating the electronic stylus system and the AR glasses 50 with each other.

### Description of Operation Modes

FIG. 3 is a state transition diagram illustrating a transition between operation modes that are performed by the input system 10 illustrated in FIG. 1. FIG. 3 illustrates three operation modes, specifically, a normal mode, a first coordinated mode, and a second coordinated mode. The normal mode refers to a mode of operation not coordinated with the AR glasses 50. First and second coordinated modes refer to modes of operation coordinated with the AR glasses 50.

T1: While in the normal mode, the input system 10 activates an input action by the electronic stylus 20 with regard to the sensor device 30 and inactivates the input action with regard to the AR glasses 50.

T2: While in the normal mode, the input system 10 is triggered by the reception of an action to start the AR-coordinated operation to go from the normal mode to the first coordinated mode.

T3: While in the first coordinated mode, the input system 10 is triggered by the reception of an action to end the AR-coordinated operation to go from the first coordinated mode to the normal mode.

T4: While in the first coordinated mode, the input system 10 activates an input action by the electronic stylus 20 with regard to both the sensor device 30 and the AR glasses 50.

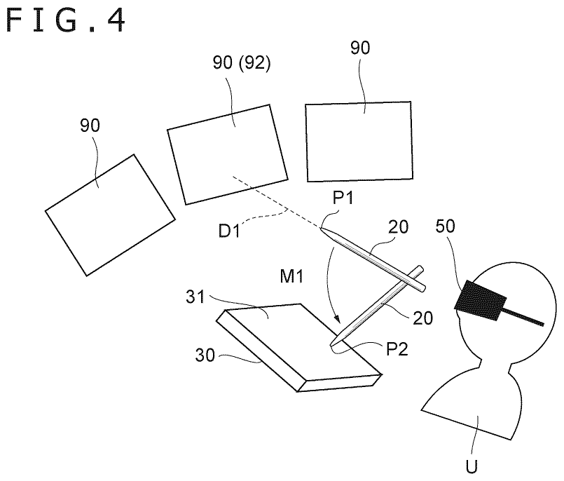

T5: While in the first coordinated mode, the input system 10 is triggered by the reception of a pick-up action for moving a virtual object 90 (see FIG. 4) as a browsing target to go from the first coordinated mode to the second coordinated mode.

T6: While in the second coordinated mode, the input system 10 receives a handwriting action on a virtual object 92 (see FIG. 5) as a working target.

T7: While in the second coordinated mode, the input system 10 is triggered by the reception of a drop-off action for the virtual object 92 to go from the second coordinated mode to the first coordinated mode.

FIG. 4 illustrates an example of the pick-up action on a virtual object 90 as a browsing target. According to the example illustrated in FIG. 4, three virtual objects 90 as browsing targets are displayed in an array on the AR glasses 50. While gripping the electronic stylus 20, the user U starts a stylus action to depress the switch 26 of the electronic stylus 20 with the stylus tip facing a pointing direction D1. Now, one of the virtual objects 90 that is aligned with the pointing direction D1 from the electronic stylus 20 is selected.

While depressing the switch 26, the user U makes a stylus action to move the stylus tip of the electronic stylus 20 along a moving direction M1. Then, the selected virtual object 90 moves downwardly in a manner to follow the moving direction M1 of the electronic stylus 20. A starting point P1 of the moving direction M1 is located at a position outside of an area provided by the touch surface 31 of the sensor device 30. An ending point P2 of the moving direction M1 is located at a position inside of the area provided by the touch surface 31 of the sensor device 30.

With the stylus tip of the electronic stylus 20 at the ending point P2, the user U makes a stylus action to release the switch 26. Then, after the selected virtual object 90 is placed on the touch surface 31 of the sensor device 30, the selected virtual object 90 functions as the virtual object 92 as a working target. In this fashion, the pick-up action is performed on the virtual object 90.

FIG. 5 illustrates an example of the drop-off action on a virtual object 92 as a working target. According to the example illustrated in FIG. 5, two virtual objects 90 as browsing targets and a virtual object 92 as a working target are displayed on the AR glasses 50. While gripping the electronic stylus 20, the user U performs an action to depress the switch 26 of the electronic stylus 20 with the stylus tip facing the touch surface 31 of the sensor device 30. The virtual object 92 as the working target on the touch surface 31 is now selected.

While depressing the switch 26, the user U makes a stylus action to move the stylus tip of the electronic stylus 20 along a moving direction M2. Then, the selected virtual object 92 moves upwardly in a manner to follow the moving direction M2 of the electronic stylus 20. A starting point P3 of the moving direction M2 is located at a position inside of the area provided by the touch surface 31 of the sensor device 30. An ending point P4 of the moving direction M2 is located at a position outside of the area provided by the touch surface 31 of the sensor device 30.

With the stylus tip of the electronic stylus 20 at the ending point P4, the user U makes a stylus action to release the switch 26. Then, after the selected virtual object 92 is placed in a gap on a pointing direction D2 from the stylus tip, the selected virtual object 92 functions as a virtual object 90 as a browsing target. In this fashion, the drop-off action is performed on the virtual object 92.

### Description of Haptic Operation

Now, a haptic operation performed by the input system 10 will be described below with reference to FIGS. 6 and 7. The haptic operation is an operation for enabling the user U who is making actions on the electronic stylus 20 to experience an analog-like feeling of using the electronic stylus 20 through haptics (sense of touch).

FIG. 6 illustrates an example of the layout of haptic devices 27 included in the electronic stylus 20 illustrated in FIG. 1. As illustrated in FIG. 6, the electronic stylus 20 includes a plurality of haptic devices 27 for giving a sense of touch from a plurality of positions along circumferential directions of the electronic stylus 20 to a part of the user U that is touching the electronic stylus 20. According to the example illustrated in FIG. 6, the haptic devices 27 are disposed in the casing 25 that has a generally regular hexagonal cross-sectional shape.

Each of the haptic devices 27 includes one or more output elements for emitting vibrations, forces, motions, or the like externally to transmit a sense of touch to the part of the user U that is touching the casing 25. Examples of the output elements include a piezoelectric device, a linear resonant actuator, an ultrasonic transducer, and an eccentric motor. According to the example illustrated in FIG. 6, the haptic devices 27 include six piezoelectric devices mounted on the inner surfaces of respective side walls of the casing 25. The haptic devices 27 are not limited to the structural details illustrated in FIG. 6, and may instead be replaced with a single module including a plurality of output elements, for example.

The MCU 23 of the electronic stylus 20 receives a command signal from the AR glasses 50 via the communication chip 24 and determines respective operation quantities of the haptic devices 27 according to action information included in the command signal. Examples of the action information include a direction and speed of movement of the electronic stylus 20 and types of the virtual objects 90 and 92.

If a feeling of the weight of the electronic stylus 20 is to be simulated, then the controller 56 of the AR glasses 50 may establish operation quantities of the haptic devices 27 in order to reflect a force (e.g., a gravitational force or a inertial force) that can act on the electronic stylus 20. For example, the controller 56 may establish operation quantities of the haptic devices 27 in order to give a sense of touch in a direction opposite the direction of movement of the electronic stylus 20, i.e., a direction toward the starting point of the direction of movement. Moreover, the controller 56 may establish operation levels of the haptic devices 27 in order to change a sense of touch depending on the speed or acceleration of movement of the electronic stylus 20. For example, operation levels of the haptic devices 27 are established such that the lower the speed or acceleration of movement of the electronic stylus 20 is, the lower the operation levels are and that the higher the speed of movement of the electronic stylus 20 is, the higher the operation levels are.

If a feeling of the weight of the virtual objects 90 and 92 is to be simulated, then the controller 56 of the AR glasses 50 may establish operation quantities of the haptic devices 27 in order to reflect a force (e.g., a frictional force or a repulsive force) that can act on the electronic stylus 20. For example, the controller 56 may establish operation levels of the haptic devices 27 in order to change a sense of touch depending on the types of the virtual objects 90 and 92. For example, operation levels of the haptic devices 27 are established such that the smaller the masses, sizes, and thicknesses of the virtual objects 90 and 92 are, the lower the operation levels are and that the larger the masses, sizes, and thicknesses of the virtual objects 90 and 92 are, the higher the operation levels are.

FIG. 7 illustrates an example of relation between movement of the electronic stylus 20 and operation of a haptic device 27. It is assumed herein that the electronic stylus 20 is moved from an upper side toward a lower side, i.e., downwardly, in FIG. 7. When the electronic stylus 20 is moved downwardly in FIG. 7, since an inertial force occurs on the electronic stylus 20 in a direction opposite the direction of movement, i.e., an upward direction, the electronic stylus 20 operates only an uppermost haptic device 27, which is depicted hatched, to assist in the inertial force. The haptic device 27 thus operated is able to create a simulated feeling of weight similar to that of a pencil made of wood.

### Summing-up of First Operation

As described above, the input system 10 according to the present embodiment includes the electronic stylus 20, the sensor device 30 including the planar stylus sensor 32 capable of detecting the position and posture of the electronic stylus 20, the wearable display device, i.e., the AR glasses 50, that can be worn by the user U to cover his or her eyes, and at least one processor for performing display control on the AR glasses 50 to display the virtual objects 90 and 92 in a display area of the AR glasses 50. The at least one processor is disposed inside or outside of the AR glasses 50 and corresponds to the host processor 34 or the controller 56 according to the embodiment.

The at least one processor performs the determining process for determining contents of a stylus action using the electronic stylus 20, on the basis of the stylus state quantity representing the position and posture of the electronic stylus 20 in the display coordinate space CS2 that is defined for the display control.

The stylus action may include a pick-up action for moving a virtual object 90 disposed outside of the sensor device 30 to the position of the sensor device 30 and a drop-off action for moving a virtual object 92 at the position of the sensor device 30 to a position outside of the sensor device 30 after the pick-up action. The user U can thus recognize with ease whether or not the virtual objects 90 and 92 are a working target.

The pick-up action or the drop-off action may include an action for dragging and dropping the virtual objects 90 and 92 by making a change in the position or direction pointed by the electronic stylus 20. The user U can thus simply switch between working states of the virtual objects 90 and 92 by dragging and dropping the virtual objects 90 and 92.

The dragging and dropping action may be activated while the switch 26 of the electronic stylus 20 is being operated. The intension of the user's action can thus be reflected easily.

The at least one processor may perform (1) a selecting process for selecting whether a stylus action performed by the user U using the electronic stylus 20 is a first action on the sensor device 30 or a second action on the AR glasses 50 and (2) a determining process for, (2a) if the stylus action performed by the user U is the first action, determining contents of the stylus action on the sensor device 30 by using the first stylus state quantity in the sensor coordinate space CS1 defined by the sensor device 30 and, (2b) if the stylus action performed by the user U is the second action, determining contents of the stylus action on the AR glasses 50 by using the second stylus state quantity in the display coordinate space CS2 defined for the display control. By alternatively selecting an action target for the electronic stylus 20, it is possible to expand the action range of the electronic stylus 20 to a space in the field of view of the user U, rather than keeping the action range to the sensor device 30. Therefore, the operability for the user U to make handwriting inputs is improved.

The at least one processor may perform (1) a selecting process for selecting whether a stylus action performed by the user U using the electronic stylus 20 is a first action on the sensor coordinate space CS1 or a second action on the display coordinate space CS2 and (2) a determining process for, (2a) if the stylus action performed by the user U is the first action, determining contents of the stylus action on the sensor coordinate space CS1 by using the first stylus state quantity in the sensor coordinate space CS1 and, (2b) if the stylus action performed by the user U is the second action, determining contents of the stylus action on the display coordinate space CS2 defined for the display control, by using the second stylus state quantity in the display coordinate space CS2. By alternatively selecting a coordinate space where the electronic stylus 20 is positioned, it is possible to expand the action range of the electronic stylus 20 to a space in the field of view of the user U, rather than keeping the action range to the sensor device 30. Therefore, the operability for the user U to make handwriting inputs is improved.

Providing the electronic stylus 20 includes a plurality of haptic devices 27 for giving a sense of touch from a plurality of positions along circumferential directions of the electronic stylus 20 to a part of the user U that is touching the electronic stylus 20, the at least one processor, i.e., the MCU 23 or the controller 56, may perform a commanding process for commanding the haptic devices 27 to operate to give the sense of touch at a position corresponding to a direction along which an inertial force or a repulsive force is produced as the electronic stylus 20 moves. In this manner, the user U who is gripping the electronic stylus 20 can have a simulated experience of a feeling of the weight of the electronic stylus 20.

Moreover, providing the electronic stylus 20 includes a haptic device 27 for giving a sense of touch to a part of the user U that is touching the electronic stylus 20, the at least one processor may perform a commanding process for commanding the haptic device 27 to change the operation quantity of the haptic device 27 depending on the speed of movement of the electronic stylus 20 or the types of the virtual objects 90 and 92. In this manner, the user U who is gripping the electronic stylus 20 can have a simulated experience of a slight difference of a feeling of the weight of the electronic stylus 20 or the virtual objects 90 and 92.

### Second Operation of Input System 10

A stylus tracking operation of the input system 10 will be described below with reference to FIGS. 8 through 10. The stylus tracking operation refers to an operation for tracking the electronic stylus 20 in the display coordinate space CS2 with use of the sensor device 30 as a reference plane.

### Description of Stylus Tracking Operation

In the case where the AR glasses 50 incorporate the cameras 53, the AR glasses 50 can have the electronic stylus 20 function as a pointing device by directly detecting the position and posture of the electronic stylus 20 with the cameras 53. If the accuracy with which to detect the position and posture of the electronic stylus 20 with the cameras 53 is not high, it is not possible to plot images highly accurately with use of the electronic stylus 20. The input system 10 performs a stylus tracking operation for tracking the electronic stylus 20 highly accurately by indirectly detecting the position and posture of the electronic stylus 20 with use of a device region 94 (see FIG. 8) of the sensor device 30 as a reference plane.

FIG. 8 illustrates a first example of how the sensor coordinate space CS1 and the display coordinate space CS2 are mapped onto each other. The sensor coordinate space CS1 represents a three-dimensional orthogonal coordinate space that is defined in the sensor device 30 and used in detection control on the electronic stylus 20. The sensor coordinate space CS1 has its origin Os set to a vertex Pm1 on the device region 94 of the stylus sensor 32, for example. The sensor coordinate space CS1 has three axes including (1) a “U-axis” extending parallel to a side of the device region 94, (2) a “V-axis” extending parallel to another side of the device region 94, and (3) a “W-axis” extending perpendicularly to the device region 94. Angles around the U-axis, the V-axis, and the W-axis are denoted respectively by φu, φv, and φw.

The display coordinate space CS2 represents a three-dimensional orthogonal coordinate space that is defined in the AR glasses 50 and used in display control on the display panel 52. The display coordinate space CS2 has its origin Od set to an intermediate point between image capturing centers Pc1 and Pc2 of the respective cameras 53, for example. The display coordinate space CS2 has three axes including an “X-axis” as a first axis extending parallel to a horizontal plane, a “Y-axis” as a second axis extending parallel to the horizontal plane, and a “Z-axis” as a third axis extending perpendicularly to the horizontal plane. Angles around the X-axis, the Y-axis, and the Z-axis are denoted respectively by θx, θy, and θz.

The device region 94 represents a reference plane for the stylus tracking operation carried out by the tracking section 62 of the AR glasses 50. A placement region 96 represents a position where a virtual object 90 is to be placed. In the sensor coordinate space CS1, there are established feature points (in the example illustrated in FIG. 8, diagonal vertexes Pm1 and Pm2 of the device region 94) where their relation to the sensor device 30 or the stylus sensor 32 is known. The sensor coordinate space CS1 can uniquely be mapped onto the display coordinate space CS2 by acquiring the state quantities of the vertexes Pm1 and Pm2 in the display coordinate space CS2 and determining coordinate transformation rules from the pair of device state quantities.

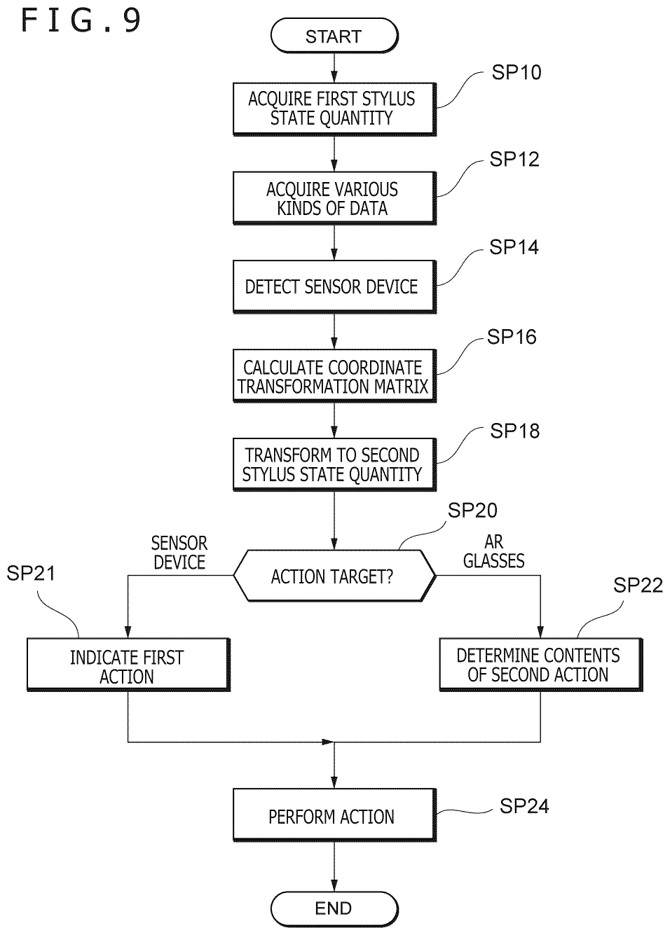

FIG. 9 is a flowchart of a stylus tracking operation performed by the AR glasses 50 illustrated in FIG. 2. The AR glasses 50 track the electronic stylus 20 in the display coordinate space CS2 by periodically or nonperiodically executing the flowchart illustrated in FIG. 9 repeatedly.

In step SP10, the data acquiring section 60 acquires a state quantity, i.e., a first stylus state quantity, representing a position and posture of the electronic stylus 20 in the sensor coordinate space CS1 from the sensor device 30.

In step SP12, the data acquiring section 60 acquires pieces of data (hereinafter referred to as “tracking data”) that correspond to the first stylus state quantity acquired in step SP10 and that are required to determine action contents. The tracking data includes an image signal, rendering information 72, and determining condition information, for example.

In step SP14, the tracking section 62 performs an image processing process on the image signal acquired in step SP12 to detect a position and posture of the sensor device 30 that is positioned at least in front of the user U. Now, a device state quantity in the display coordinate space CS2 is obtained.

In step SP16, the tracking section 62 calculates a coordinate transformation matrix for transforming the sensor coordinate space CS1 to the display coordinate space CS2, by using the transformation data 78 acquired in step SP12 and the device state quantity acquired in step SP14.

In step SP18, the tracking section 62 transforms the first stylus state quantity acquired in step SP10 to a state quantity, i.e., a second stylus state quantity, representing a position and posture of the electronic stylus 20 in the display coordinate space CS2, by using the coordinate transformation matrix calculated in step SP16.

In step SP20, the action processing section 64 determines whether an action target of the electronic stylus 20 is the sensor device 30 or the AR glasses 50, by using the determining condition information acquired in step SP12. If the action processing section 64 decides that the action target is the sensor device 30 (step SP20: sensor device), then the action processing section 64 goes to step SP21. On the other hand, if the action processing section 64 decides that the action target is the AR glasses 50 (step SP20: AR glasses), then the action processing section 64 goes to step SP22.

In step SP21, the action processing section 64 instructs the electronic stylus 20 to perform an action, i.e., a first action, on the sensor device 30 as the action target, after which the action processing section 64 goes to step SP24.

In step SP22, the action processing section 64 determines contents of an action, i.e., a second action, to be performed by the electronic stylus 20 on the AR glasses 50 as the action target, by using the second stylus state quantity obtained after the transformation in step SP18. Thereafter, the action processing section 64 goes to step SP24.

In step SP24, the sensor device 30 or the AR glasses 50 executes the action, i.e., the first action or the second action, performed by the electronic stylus 20. In this manner, the electronic stylus 20 can continuously be tracked with high accuracy by repetitive execution of the flowchart illustrated in FIG. 9.

### Process of Acquiring State Quantities

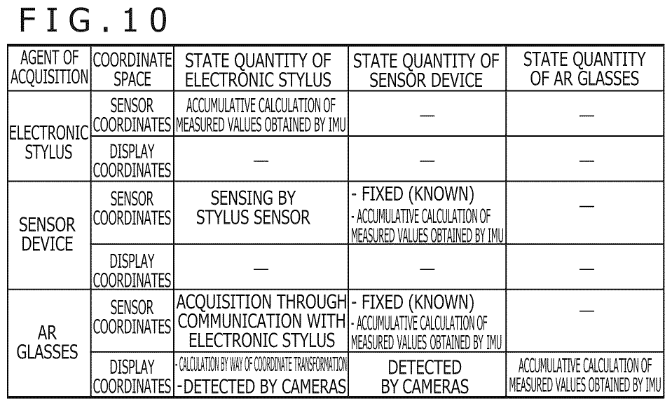

FIG. 10 is a diagram illustrating an example of a process of acquiring state quantities of devices in the sensor coordinate space CS1 and the display coordinate space CS2. Specifically, FIG. 10 illustrates a list of (1) agents of acquisition of state quantities, (2) types of coordinate spaces, (3) state quantities of the electronic stylus 20, (4) state quantities of the sensor device 30, and (5) state quantities of the AR glasses 50.

### (1) First State Quantity With Regard to the Electronic Stylus 20 (Sensor Coordinate Space Cs1)

The electronic stylus 20 acquires a first state quantity with regard to the electronic stylus 20 by measuring distances that its position and posture have moved, with use of the IMU 22 of its own, and accumulatively adding the measured distances. The sensor device 30 acquires the first state quantity with regard to the electronic stylus 20 via communication with the electronic stylus 20. The AR glasses 50 acquire the first state quantity with regard to the electronic stylus 20 via communication with the electronic stylus 20 or the sensor device 30.

### (2) Second State Quantity With Regard to the Electronic Stylus 20 (Display Coordinate Space Cs2)

Since the electronic stylus 20 and the sensor device 30 are not involved in the rendering process performed by the AR glasses 50, their acquisition of the second state quantity with regard to the electronic stylus 20 may be omitted. The AR glasses 50 acquire the second state quantity with regard to the electronic stylus 20 via the coordinate transformation from the sensor coordinate space CS1 to the display coordinate space CS2. In addition to or independently of the second state quantity thus acquired, the AR glasses 50 acquire the second state quantity with regard to the electronic stylus 20 via the detecting process using the cameras 53.

### (3) First State Quantity With Regard to the Sensor Device 30 (Sensor Coordinate Space Cs1)

Since the electronic stylus 20 is not involved in a handwriting process performed by the sensor device 30, its acquisition of the first state quantity with regard to the sensor device 30 may be omitted. As the sensor device 30 has the sensor coordinate space CS1 defined uniquely, the sensor device 30 is holding the first state quantity with regard to itself as a fixed value. Alternatively, the sensor device 30 acquires the first state quantity representing a position and posture relative to a reference state, i.e., the fixed value, by measuring distances that its position and posture have moved, with use of an undepicted IMU of its own, and accumulatively adding the measured distances. Inasmuch as the AR glasses 50 share the definition of the sensor coordinate space CS1 in advance, the AR glasses 50 are holding the first state quantity with regard to the sensor device 30 as a fixed value. In addition to or independently of the first state quantity thus held, the AR glasses 50 acquire the first state quantity with regard to the sensor device 30 via communication with the sensor device 30.

### (4) Second State Quantity With Regard to the Sensor Device 30 (Display Coordinate Space Cs2)

Since the electronic stylus 20 and the sensor device 30 are not involved in the rendering process performed by the AR glasses 50, their acquisition of the second state quantity with regard to the sensor device 30 may be omitted. The AR glasses 50 acquire the second state quantity with regard to the sensor device 30 via the detecting process using the cameras 53.

### (5) First State Quantity With Regard to the Ar Glasses 50 (Sensor Coordinate Space Cs1)

Since any of the electronic stylus 20, the sensor device 30, and the AR glasses 50 do not require the first state quantity with regard to the AR glasses 50, their acquisition of the first state quantity with regard to the AR glasses 50 may be omitted.

### (6) Second State Quantity With Regard to the AR Glasses 50 (Display Coordinate Space CS2)

Since the electronic stylus 20 and the sensor device 30 are not involved in the rendering process performed by the AR glasses 50, their acquisition of the second state quantity with regard to the AR glasses 50 may be omitted. The AR glasses 50 acquire the first state quantity with regard to the AR glasses 50 by measuring distances that their position and posture have moved, with use of the IMU 54 of its own, and accumulatively adding the measured distances.

As illustrated in FIG. 10, the input system 10 has the electronic stylus 20, the sensor device 30, and the AR glasses 50 exchange their state quantities with each other. If the input system 10 is able to acquire stylus feature quantities through a plurality of sections, then the input system 10 can make selections and corrections in order to increase the accuracy with which to detect positions and postures.

### Summing-up of the Second Operation

As described above, the input system 10 according to the present embodiment includes the electronic stylus 20, the sensor device 30 including the planar stylus sensor 32 capable of detecting the position and posture of the electronic stylus 20, the wearable display device, i.e., the AR glasses 50, that can be worn by the user U to cover his or her eyes and that includes the cameras 53 for capturing images of a space at least in front of the user U, and at least one processor for performing display control on the AR glasses 50 to display the virtual objects 90 and 92 in a display area of the AR glasses 50. The at least one processor is disposed inside or outside of the AR glasses 50 and corresponds to the controller 56 according to the embodiment.

The at least one processor performs (1) a detecting process that performs an image processing process on image signals acquired from the cameras 53 to detect the sensor device 30, and acquires a device state quantity representing a position and posture of the sensor device 30 in the display coordinate space CS2 defined for the display control, (2) a calculating process that calculates coordinate transformation rules for mapping the sensor coordinate space CS1 defined by the sensor device 30 onto the display coordinate space CS2 by using the device state quantity acquired by the detecting process, and (3) a transforming process that transforms a first stylus state quantity representing a position and posture of the electronic stylus 20 in the sensor coordinate space CS1 to a second stylus state quantity representing a position and posture of the electronic stylus 20 in the display coordinate space CS2 according to the calculated coordinate transformation rules.

By thus detecting a position and posture of the electronic stylus 20 with use of the position of the stylus sensor 32 or the device region 94 as a reference plane, it is possible to determine highly accurately a second stylus state quantity representing a position and posture of the electronic stylus 20 in the display coordinate space CS2.

The at least one processor may further perform the tracking process for tracking the electronic stylus 20 in the display coordinate space CS2 by successively repeating the detecting process, the calculating process, and the transforming process. This makes it possible to track the electronic stylus 20 with high accuracy and continue to track the electronic stylus 20 through the detection with the sensor device 30 even if the cameras 53 fail to detect the electronic stylus 20.

The first stylus state quantity represents a detected value detected by the stylus sensor 32 or a cumulative value obtained by accumulating distances that the electronic stylus 20 has moved and that have been successively measured by the inertial sensor, i.e., the IMU 22, of the electronic stylus 20. If the at least one processor fails to obtain a detected value, then the at least one processor may transform a cumulative value that represents the first stylus state quantity to a second stylus state quantity in the transforming process. Even if the stylus sensor 32 fails to detect the electronic stylus 20, the tracking of the electronic stylus 20 can be continued through the measurement with the electronic stylus 20.

The at least one processor may further perform an acquiring process for acquiring a corrective quantity for bringing the cumulative value closer to the detected value and, in the transforming process, may correct the cumulative value by using the corrective quantity and transform the corrected cumulative value to a second stylus state quantity. This makes it possible to obtain a calculated result closer to the detected value even though the cumulative value is used.

Moreover, the second stylus state quantity represents a transformed value obtained by the transforming process or a detected value obtained by detection of the electronic stylus 20 in the detecting process. In this case, if a transformed value cannot be acquired, the at least one processor may further perform the determining process for determining contents of actions on the display coordinate space CS2 by using the detected value that represents the second stylus state quantity. Even if no proper transformation is performed, the tracking of the electronic stylus 20 can be continued through the detection with the cameras 53.

Moreover, the at least one processor may further perform the acquiring process for acquiring a corrective quantity for bringing the detected value closer to the transformed value, and, in the determining process, the at least one processor may correct the detected value by using the corrective quantity and determine contents of actions on the display coordinate space CS2 by using the corrected detected value. This makes it possible to obtain a calculated result closer to the transformed value even though the detected value is used.

### Third Operation of Input System 10

A seamlessly displaying operation of the input system 10 will be described below with reference to FIGS. 11 through 13. The seamlessly displaying operation refers to an operation for displaying virtual objects 90 and 92 (see FIGS. 4 and 5) uninterruptedly without joints.

### Description of Seamlessly Displaying Operation

FIG. 11 illustrates an example of a process of designating a placement region 100 in the display coordinate space CS2. The sensor coordinate space CS1 and the display coordinate space CS2 illustrated in FIG. 11 are defined in the same manner as that of FIG. 8, and their definition will be omitted below. The placement region 100 where a virtual object is to be placed is established in such a manner as to cover the device region 104 bounded by the boundary line 102 of the sensor device 30. In this case, the placement region 100 includes the device region 104 positioned inside of the boundary line 102 and an outer region 106 positioned outside of the boundary line 102.

FIG. 12 illustrates an example of a mode of displaying a seamless object 110. The seamless object 110 that is seamless at the boundary line 102 of the sensor device 30 is displayed on the display panel 52 of the AR glasses 50. The seamless object 110 includes handwritten content created by a handwriting action on the sensor device 30. The seamless object 110 is made up of an inner object 112 positioned inside of the boundary line 102 and an outer object 114 positioned outside of the boundary line 102. According to the example illustrated in FIG. 12, the outer object 114 is displayed in a color lighter than or a brightness lower than that of the inner object 112.

If the sensor device 30 does not have a display function or if the sensor device 30 is not displaying the seamless object 110, both the inner object 112 and the outer object 114 are displayed on the display panel 52. In other words, the placement region 100 illustrated in FIG. 11 is designated as a position for displaying the seamless object 110.

If the sensor device 30 has a display function and is displaying part of the seamless object 110, then only the outer object 114 is displayed on the display panel 52. In other words, the outer region 106 illustrated in FIG. 11 is designated as a position for displaying the seamless object 110. FIG. 13 illustrates an example of a result of an action on the seamless object 110. According to the example illustrated in FIG. 13, the seamless object 110 is displayed on the display panel 52 of the AR glasses 50, as with the example illustrated in FIG. 12. While the user U who is gripping the electronic stylus 20 is designating a point 116 of instruction, i.e., beneath the sensor device 30, in the seamless object 110, the user U starts a stylus action to depress the switch 26 of the electronic stylus 20 and performs a dragging action to move the stylus tip from the point 116 of instruction to a point 118 of interest. Then, the AR glasses 50 update the contents displayed on the display panel 52, such that the seamless object 110 moves downwardly to the right. The point 118 of interest now comes into the device region 104, allowing the user U to perform a handwriting action in a peripheral region that includes the point 118 of interest.

### Summing-up of Third Operation

As described above, the input system 10 according to the present embodiment includes the electronic stylus 20, the sensor device 30 including the planar stylus sensor 32 capable of detecting the position and posture of the electronic stylus 20, the wearable display device, i.e., the AR glasses 50, that can be worn by the user U to cover his/her eyes, and at least one processor for performing display control on the AR glasses 50 to display the virtual objects 90 and 92 in a display area of the AR glasses 50. The at least one processor is disposed inside or outside of the AR glasses 50 and corresponds to the controller 56.

The at least one processor performs the rendering process for displaying the seamless object 110 that represents the virtual objects 90 and 92 that include handwritten content created by a handwriting action on the sensor device 30 and that are seamless at the boundary line 102 of the device region 104 provided by the sensor device 30.

With this arrangement, it is possible to expand a working range provided by the electronic stylus 20 outside of the boundary line 102, rather than keeping the working range to the sensor device 30, thereby improving the operability for the user U to make handwriting inputs.

Moreover, if the sensor device 30 is not displaying part of the seamless object 110 in the device region 104 in the rendering process, then the at least one processor may designate the placement region 100 inclusive of the device region 104 as the position of the seamless object 110. This makes it easy to keep handwritten content continuous and contiguous in the periphery of the boundary line 102.

Further, if the sensor device 30 is displaying part of the seamless object 110 in the device region 104 in the rendering process, then the at least one processor may designate the outer region 106 exclusive of the device region 104 as the position of the seamless object 110. This makes it possible to restrain images from blurring attributable to overlapping display of handwritten content. The rendering process may include an assigning process for assigning a visual effect to the outer object 114 outside of the device region 104 to make the outer object 114 more distinguishable from the inner object 112 inside of the device region 104, the outer object 114 and the inner object 112 making up the seamless object 110. The visual effect thus assigned allows the user U to recognize at a glance the range where a handwriting action is effective, on account of the visual contrast between the inner object 112 and the outer object 114.

### Modifications

The present disclosure is not limited to the details and features according to the embodiment described above, and changes and modifications may be made in the embodiment without departing from the scope of the disclosure. Various details and features according to the embodiment may be put together in desired combinations unless such combinations lead to technically contradictory results. Further, some of the steps of the flowchart illustrated in FIG. 9 may be omitted from execution or changed in the order of execution unless such an omission or change result in technical contradictions.

In the above embodiment, it has been described by way of example that the wearable display device displays an AR space according to the AR technology. However, the wearable display device may instead display a space according to the mixed reality (MR) technology or the virtual reality (VR) technology.

In the above embodiment, it has been described by way of example that the controller 56 and the storage 58 are incorporated in the AR glasses 50 illustrated in FIG. 2. The present disclosure is not limited to such configurational details. Rather, the AR glasses 50 may be connected to another separate computer, and the other separate computer may have some or all of the functions performed by the controller 56, e.g., the tracking section 62, the action processing section 64, the rendering section 66, and the ink data generating section 68.

In the above embodiment, it has been described by way of example that the AR glasses 50 illustrated in FIG. 2 communicate via the communication chip 55. However, the AR glasses 50 may have a receiver circuit for receiving uplink signals from the sensor device 30 in combination with or separately from the communication chip 55. If the electronic stylus 20 is an AES stylus, then the uplink signals are signals transmitted from the sensor device 30 to the electronic stylus 20. The uplink signals are thus able to exchange data while benefitting from the AES principle.

1. An input system comprising:
an electronic stylus;
a sensor device including a planar stylus sensor configured to detect a position and posture of the electronic stylus;
a wearable display device including a camera configured to capture an image of a space at least in front of a user; and
at least one processor configured to perform display control on the wearable display device to display a virtual object in a display area of the wearable display device;
wherein the at least one processor performs:
a detecting process that performs an image processing process on an image signal acquired from the camera to detect the sensor device and acquires a device state quantity representing a position and posture of the sensor device in a display coordinate space defined for the display control,
a calculating process that calculates coordinate transformation rules for mapping a sensor coordinate space defined by the sensor device onto the display coordinate space by using the device state quantity acquired by the detecting process, and
a transforming process that transforms a first stylus state quantity representing a position and posture of the electronic stylus in the sensor coordinate space to a second stylus state quantity representing a position and posture of the electronic stylus in the display coordinate space according to the calculated coordinate transformation rules.

2. The input system according to claim 1,
wherein the at least one processor further performs a determining process for determining contents of a stylus action using the electronic stylus based on the second stylus state quantity.

3. The input system according to claim 2,
wherein the stylus action includes:
a pick-up action for moving the virtual object disposed outside of the sensor device to the position of the sensor device, and
a drop-off action for moving the virtual object at the position of the sensor device to a position outside of the sensor device after the pick-up action.

4. The input system according to claim 3,
wherein the pick-up action or the drop-off action includes an action for dragging and dropping the virtual object by making a change in a position or direction pointed by the electronic stylus.

5. The input system according to claim 4,
wherein the action for dragging and dropping the virtual object is activated while a switch of the electronic stylus is being operated.

6. The input system according to claim 1,
wherein the at least one processor further performs:
a selecting process for selecting whether a stylus action performed by the user using the electronic stylus is a first action on the sensor device or a second action on the wearable display device, and
a determining process for, if the stylus action performed by the user is the first action, determining contents of the stylus action on the sensor device by using the first stylus state quantity, and if the stylus action performed by the user is the second action, determining contents of the stylus action on the wearable display device by using the second stylus state quantity.

7. The input system according to claim 1,
wherein the at least one processor further performs:
a selecting process for selecting whether a stylus action performed by the user using the electronic stylus is a first action on the sensor coordinate space or a second action on the display coordinate space, and
a determining process for, if the stylus action performed by the user is the first action, determining contents of the stylus action on the sensor coordinate space by using the first stylus state quantity, and if the stylus action performed by the user is the second action, determining contents of the stylus action on the display coordinate space by using the second stylus state quantity.

8. The input system according to claim 1,
wherein the electronic stylus includes a plurality of haptic devices configured to give a sense of touch from a plurality of positions along circumferential directions of the electronic stylus to a part of the user that is touching the electronic stylus, and
the at least one processor further performs a commanding process for commanding the haptic devices to operate to give the sense of touch at a position corresponding to a direction along which an inertial force or a repulsive force is produced as the electronic stylus moves.

9. The input system according to claim 1,
wherein the electronic stylus includes a haptic device configured to give a sense of touch to a part of the user that is touching the electronic stylus, and
the at least one processor further performs a commanding process for commanding the haptic device to change an operation quantity of the haptic device depending on speed of movement of the electronic stylus or a type of the virtual object.

10. The input system according to claim 4,
wherein the at least one processor further performs a rendering process for displaying handwritten content created by the stylus action overlappingly on the virtual object disposed at the position of the sensor device, after the pick-up action but before the drop-off action.

11. The input system according to claim 1,
wherein the at least one processor further performs a tracking process for tracking the electronic stylus in the display coordinate space by successively repeating the detecting process, the calculating process, and the transforming process.

12. The input system according to claim 11,
wherein the first stylus state quantity represents:
a detected value detected by the stylus sensor, or
a cumulative value obtained by accumulating distances that the electronic stylus has moved and that have been successively measured by an inertial sensor of the electronic stylus, and,
in the transforming process, the at least one processor transforms the cumulative value as the first stylus state quantity to the second stylus state quantity if the detected value is not acquired.

13. The input system according to claim 12,
wherein the at least one processor further performs an acquiring process for acquiring a corrective quantity for bringing the cumulative value closer to the detected value, and,
in the transforming process, the at least one processor corrects the cumulative value by using the corrective quantity and transforms the corrected cumulative value to the second stylus state quantity.

14. The input system according to claim 11,
wherein the second stylus state quantity represents:
a transformed value obtained by the transforming process, or
a detected value obtained by detection of the electronic stylus in the detecting process, and
the at least one processor further performs a determining process for determining contents of the stylus action in the display coordinate space by using the detected value as the second stylus state quantity if the transformed value is not acquired.

15. The input system according to claim 14,
wherein the at least one processor further performs an acquiring process for acquiring a corrective quantity for bringing the detected value closer to the transformed value, and,
in the determining process, the at least one processor corrects the detected value by using the corrective quantity and determines contents of a stylus action in the display coordinate space by using the corrected detected value.

16. The input system according to claim 1,
wherein the at least one processor further performs a rendering process for displaying a seamless object representing the virtual object that includes handwritten content formed by a handwriting action on the sensor device and that is seamless at a boundary line of a device region provided by the sensor device.

17. The input system according to claim 16,
wherein, if the sensor device is not displaying part of the seamless object in the device region in the rendering process, then the at least one processor designates a region inclusive of the device region as a position of the seamless object.

18. The input system according to claim 16,
wherein, if the sensor device is displaying part of the seamless object in the device region in the rendering process, then the at least one processor designates a region exclusive of the device region as a position of the seamless object.

19. The input system according to claim 16,
wherein the rendering process includes an assigning process for assigning a visual effect to an outer object outside of the device region to make the outer object more distinguishable from an inner object inside of the device region, the outer object and the inner object making up the seamless object.

20. The input system according to claim 19,
wherein the assigning process includes an unsharpening process for converting the outer object to an object that is less sharp than the inner object.

21. The input system according to claim 20,
wherein the unsharpening process is a color processing process for lowering lightness or saturation, a masking process for lowering a spatial frequency characteristic, or an image scaling-down process for reducing a size of an image.

22. The input system according to claim 19,
wherein the assigning process includes an image deforming process for placing the outer object in a deformed state.

23. The input system according to claim 22,
wherein the image deforming process is an image scaling-down process for reducing a size of an image of the outer object or a panoramic processing process for placing the outer object in a curved layout in surrounding relation to the user.

24. An input method using an input system,
the input system including:
an electronic stylus,
a sensor device including a planar stylus sensor configured to detect a position and posture of the electronic stylus,
a wearable display including a camera configured to capture an image of a space at least in front of the user, and
at least one processor for performing display control on the wearable display device to display a virtual object in a display area of the wearable display device,
the input method comprising:
by the at least one processor,
a detecting step that performs an image processing process on an image signal acquired from the camera to detect the sensor device and acquires a device state quantity representing a position and posture of the sensor device in a display coordinate space defined for the display control;
a calculating step that calculates coordinate transformation rules for mapping a sensor coordinate space defined by the sensor device onto the display coordinate space, by using the device state quantity acquired by the detecting step; and
a transforming step that transforms a first stylus state quantity representing a position and posture of the electronic stylus in the sensor coordinate space to a second stylus state quantity representing a position and posture of the electronic stylus in the display coordinate space according to the calculated coordinate transformation rules.
